(19) United States
(12) Patent Application Publication
(10) Pub. No.: US 2026/0026438 A1
(43) Pub. Date: Jan. 29, 2026

(54) Agricultural Harvesting Machine

(71) Applicant: PÖTTINGER Landtechnik GmbH, Grieskirchen (AT)

(72) Inventors: Markus Baldinger, Grieskirchen (AT); Martin Jungreithmayer, Grieskirchen (AT); Andreas Mair, Grieskirchen (AT); Norbert Angleitner, Grieskirchen (AT)

(21) Appl. No.: 19/275,632

(22) Filed: Jul. 21, 2025

(30) Foreign Application Priority Data
Jul. 25, 2024 (DE) 10 2024 121 218.7

(51) Int. Cl. A01D 57/20; A01D 57/12

(52) U.S. Cl. CPC A01D 57/20; A01D 57/12

(57) ABSTRACT

An agricultural harvesting machine including at least one merger unit that has a pick-up conveyor for picking up harvested material from the ground and a cross conveyor having a horizontal conveyor track for conveying the picked-up harvested material transversely to the direction of travel, wherein an auxiliary feeder is provided in at least one edge portion of the cross conveyor above its conveyor track for discharging accumulations of harvested material on the conveyor track and/or for cleaning the conveyor track of the cross conveyor, and wherein the auxiliary feeder comprises a spiked and/or brush rotor with conveyor tines and/or brushes rotating about an axis of rotation.

### CROSS-REFERENCE TO RELATED APPLICATIONS

This application claims benefit under 35 USC § 119 of DE Application No. 10 2024 121 218.7 filed 25 Jul. 2024, which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT Not Applicable

SEQUENCE LISTING

Not Applicable

### STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to an agricultural harvesting machine comprising at least one merger unit which comprises a pick-up conveyor for picking up harvested material from the ground and a cross conveyor having a horizontal conveyor track for conveying the picked-up harvested material transversely to the direction of travel, wherein an auxiliary feeder is provided in at least one edge portion of the cross conveyor above its conveyor track for discharging accumulations of harvested material on the conveyor track and/or for cleaning the conveyor track of the cross conveyor.

### 2. Description of Related Art

In case of mergers, unwanted accumulations of harvested material often occur in the end areas of the conveyor track if the cross conveyor is unable to transport the crop loaded onto its conveyor belt quickly enough or completely, which can happen in particular in the upstream end or edge portion of the merger. In portions further downstream or at the discharge end, the harvested material located there is “pushed” by the harvested material still further upstream, in addition to the conveying effect of the belt section itself, while in the upstream end or edge portion, this additional pushing effect is lost due to the lack of harvested material further upstream and the cross conveyor itself does not develop enough grip to remove the accumulations of harvested material on its own.

As cross conveyors, such mergers regularly have endless circulating conveyor track or possibly also several conveyor elements arranged next to each other, such as belts, which can be covered by curved protective plates in the deflection area and on the longitudinal edges. To prevent the fed harvested material from falling off the rear of the conveyor track, upright limiting plates or walls are often provided, which may also be rounded in the edge areas of the cross conveyor. The harvested material tends to get tangled at the edge areas of the cover or boundary plates, so that unwanted accumulations of harvested material can build up in the edge areas of the cross conveyor, which the cross conveyor can no longer remove on its own.

The accumulations of harvested material are a particular risk with longer clippings or with harvested material that have been processed by a tedder before collection, which often leads to entanglement of the stalk-shaped harvested material.

Various cleaning measures with additional auxiliary feeders have already been proposed to protect the cross conveyor from such unwanted accumulations of harvested material in the edge areas or to clean the cross conveyor again when crop builds up. For example, the patent document EP 2 839 732a1 shows a merger of the type mentioned above, in which a rubber-tired wheel is provided as an auxiliary feeder for cleaning the cross conveyor belt, which is mounted on the rear impact wall with the axis of rotation pointing in the direction of travel and is arranged slightly above the cross conveyor, so that a conveying gap remains between the tires of the wheel and the cross conveyor track, through which the harvested material can be conveyed and the cross conveyor track can be cleaned as a result. However, such a rubber-tired cleaning wheel only has a limited conveying effect, even if it is driven, and is difficult to position in terms of its height above the cross conveyor belt. If the cleaning wheel is mounted too close above the cross conveyor track, the conveying gap becomes very small so that larger quantities of crop can no longer be reliably conveyed. On the other hand, if the cleaning wheel is mounted too high above the cross conveyor, the conveying effect suffers, which in turn can lead to blockages.

The patent document DE 10 2021 125 408 A1 proposes upright auxiliary feeder tracks as auxiliary feeders in the edge areas of the cross conveyor track, which are arranged in front of the rear impact wall or form an edge portion of the impact wall. However, such auxiliary feeder tracks located at the rear impact wall are not only structurally complex to integrate into the impact wall, but also have only a limited conveying effect with regard to blockages that build up further forward on the cross conveyor in the direction of travel, for example due to the edge-side protective plates that surround the cross conveyor track and on which long-stalked harvested material can become entangled.

The patent document EP 3 278 656 A1 attempts to solve the problem of unwanted accumulations of harvested material directly on the cross conveyor track itself by mounting drive strips on the cross conveyor track, which are positioned at an angle forward in the conveying direction in order to achieve a more aggressive conveying effect.

It is the underlying object of the present invention to provide an improved agricultural harvesting machine of the type, which avoids disadvantages of the prior art and further develops the latter in an advantageous manner. In particular, blockages on the cross conveyor are to be reliably avoided and the cross conveyor is also to be cleaned cleanly in its edge areas in merging operation in order to save belt cleaning times without impairing a uniform harvest flow on the cross conveyor or requiring structurally complex additional units.

### SUMMARY OF THE DISCLOSURE

According to the invention, the object is achieved with an agricultural harvesting machine comprising at least one merger unit which comprises a pick-up conveyor for picking up harvested material from the ground and a cross conveyor having a horizontal conveyor track for conveying the picked-up harvested material transversely to the direction of travel, wherein an auxiliary feeder is provided in at least one edge portion of the cross conveyor above its conveyor track for discharging accumulations of harvested material on the conveyor track and/or for cleaning the conveyor track of the cross conveyor, and wherein the auxiliary feeder has a spiked and/or brush rotor with conveyor tines and/or brushes rotating about an axis of rotation.

A spiked and/or brush rotor is therefore proposed as an auxiliary feeder above the conveyor track of the cross conveyor, comprising conveyor tines and/or brushes rotating around an axis of rotation. Such rotating conveyor tines or conveyor brushes have a significantly higher conveying and entrainment effect than a rubber-tired cleaning wheel and at the same time allow the harvested material to be conveyed sufficient air on the cross conveyor to be able to convey even larger accumulations, as the harvested material does not have to squeeze through a narrow conveying gap as with a rubber-tired cleaning wheel. At the same time, compared to a stationary conveyor belt on the rear impact surface, a high conveying effect can also be achieved in areas above the cross conveyor that are spaced apart from its rear edge.

In a further development of the invention, the spiked and/or brush rotor can have a horizontal axis of rotation which can be aligned at least approximately parallel to the direction of travel. With such an axis of rotation alignment, the conveyor tines and/or brushes can rotate in upright planes which are aligned transversely to the direction of travel, so that the conveyor tines and/or brushes face the upper side of the conveyor track of the cross conveyor in a portion of their revolving path and can thus pierce into the harvested material lying on the cross conveyor and accordingly achieve a particularly high conveying effect.

In a further development of the invention, the spiked and/or brush rotor can have pickup- type scraper members between which the conveyor tines and/or brushes are arranged, wherein the conveyor tines and/or brushes can project beyond the scraper members onto the cross conveyor in a portion of the revolving path facing the conveyor track of the cross conveyor in order to pierce into the harvested material lying there and to be able to carry it along. The scraper members prevent the harvested material from getting caught or tangled on the conveyor tines and/or brushes and ensure that the harvested material is scraped off the conveyor tines and/or brushes again when the harvested material leaves the intended area of action of the spiked and/or brush rotor.

The scraper members can in particular extend in an arc-shaped manner around the axis of rotation and have a contouring which, in interaction with the revolving path of the conveyor tines and/or brushes, ensures that the conveyor tines and/or brushes retract between the scraper members towards the depositing region of the spiked and/or brush rotor or reduce their protruding tine and/or brush length in order to scrape the harvested material off the scraper members.

Even if several scraper members spaced apart from each other by a gap, between which the conveyor tines and/or brushes run, can achieve a high scraper effect, several scraper members do not necessarily have to be provided, but it may also be sufficient to provide a scraper member next to the rotating conveyor tines and/or brushes so that, for example, an arc-shaped scraper plate or a scraper member is provided on only one side of the spiked and/or brush rotor. If the scraper member is positioned close enough to the conveyor tines and/or brushes, a sufficient scraping effect can still be achieved. For example, a gap between the scraper member and the conveyor tines can be narrower or smaller than the diameter of the conveyor tines or in the range of 50%-200% or 50%-150% of the tine diameter.

Advantageously, such a scraper member may have a closed ring contour around the axis of rotation, although a ring segment or a spiral segment around the axis of rotation may also be sufficient. The scraper member can in particular be a scraper plate, which can be provided between the rotor and an upright rear wall of the mergers, in particular can be aligned essentially parallel to the plane of rotation of the conveyor tines and/or brushes, and independently of this can have an oval or elliptical contour or a flattened ring contour.

In particular, the conveyor tines or brushes can be completely retracted between the scraper members in a revolving path portion that is turned away from the conveyor track of the cross conveyor and/or oriented toward an upper side, or, if there is only one scraper member, —when viewed in the direction of the axis of rotation—so that harvest material thrown onto the cross conveyor with too much momentum cannot become caught on the upper side of the spike or brush rotor and there is no risk of injury there. On the upper side of the revolving path, the scraper members can also be connected to one another or form a slot-free enclosure around the circular path. If there is only one scraper member, it can be widened on the upper side to form an enclosure that covers the conveyor tines and/or brushes or extends over their revolving path.

At least in the region in which the conveyor tines and/or brushes project beyond the one or more scraper members, the one or more the scraper members can form strip-shaped scraper plates made of sheet metal or plastic and define a gap between them, through which the conveyor tines and/or brushes can pass and project beyond the scraper members.

The conveyor tines and/or brushes can advantageously be configured to be elastically yielding in order to be able to spring away elastically or bend away yielding in the intended operation under the effect of the harvested material to be conveyed in the manner of a bending beam. For example, rubber-elastic brushes or plastic tines can be used, the stiffness of which is low enough to be able to deform under the pressure of the harvested material. However, tines made of metal or steel are also possible, wherein the desired flexibility can be achieved through appropriate slenderness and/or choice of material, such as spring steel.

In a further development of the invention, the conveyor tines and/or brushes are characterized by a slender, elongated contour, wherein a ratio of the protruding length of the conveyor tines and/or brushes to their diameter or thickness can be an integral multiple. For example, the conveyor tines and/or brushes may be more than three times or more than five times or more than ten times longer than they are thick.

For example, the conveyor tines and/or brushes can be configured in the form of elastic fingers that protrude away from the axis of rotation. Such fingers can be thicker in cross-section than steel pins or brushes, but still have—similar to human fingers—an overall elongated, slender contour, wherein the finger length can be a multiple of the finger thickness.

In a further development of the invention, the conveyor tines, in particular the fingers, can taper slightly towards their protruding tip.

Sufficient yielding of the conveyor tines and/or brushes can be particularly advantageous if the spiked and/or brush rotor is mounted so that it can rotate freely or is only driven by the harvested material itself. In this case, the harvested material running onto the spiked and/or brush rotor can easily bend its conveyor tines and/or brushes and thus generate a rotational driving force more easily.

In an alternative further development of the invention, however, the spiked and/or brush rotor can also be rotationally driven by an external drive, for example by an electric motor or an oil motor or also by a coupling or an operational connection to the drive of the cross conveyor. An externally energy-operated rotary drive of the spiked and/or brush rotor can further increase the conveying effect and ensure even more reliably that unwanted accumulations of harvested material can be discharged.

In an advantageous further development of the invention, the rotor drive can be configured with variable speed, for example in order to increase the conveying speed when accumulations of harvested material build up. In the case of an electric or hydraulic motor, this can be achieved by adjusting the motor speed; in the case of a geared coupling to the cross conveyor, for example, by means of an adjustable gearbox.

Advantageously, sensory detection of accumulations of harvested material can be provided, for example with the aid of a non-contact sensor or also a sensor for detecting the height of the carpet of harvested material building up on the cross conveyor, wherein the drive of the spiked and/or brush rotor can then be set in motion and/or the drive speed increased if the sensor system provides a corresponding signal which can indicate, for example, that the height of the carpet of harvested material exceeds a threshold value.

Even with a non-variable-speed drive, an externally energy-operated rotor drive can be used to set a conveying speed of the spiked and/or brush rotor that deviates from the conveying speed of the cross conveyor, for example, it can be increased compared to the cross conveyor conveying speed. An increased conveying speed of the spiked and/or brush rotor, for example, can generally reliably prevent the harvested material from piling up at the edge of the cross conveyor.

The revolving path of the conveyor tines and/or brushes can be circular, wherein the conveyor tines or brushes can, for example, be rigidly mounted on an axle-shaped or sleeve-shaped tine or brush carrier, which is rotatably mounted around the axis of rotation. In this case, the conveyor tines and/or brushes rotate uncontrolled around the axis of rotation. As explained above, the conveyor tines and/or brushes can nevertheless be immersed or emerge further in relation to the at least one scraper member, for example in that the scraper members do not have a circular arc-shaped contour, but instead move increasingly further away from the axis of rotation in the manner of a parabola towards edge portions of the conveying region, so that the conveyor tines and/or brushes at the beginning of the conveying region can be moved further away from the axis of rotation. At the beginning of the conveying area, the conveying tines or brushes protrude from the slots between the scraper members and increasingly protrude further and then retract or plunge further between the scraper members towards the discharge area.

The uneven projection dimension of the conveyor tines and/or brushes beyond the at least one scraper member can advantageously comprise a maximum in a circulation area around a perpendicular to the cross conveyor, for example at about 6 o'clock, and become continuously smaller in adjacent areas upstream and downstream.

In a further development of the invention, the scraper or scrapers can also be provided in only a very narrow sector around the axis of rotation, wherein this sector can also be positioned asymmetrically to a vertical plane through the axis of rotation if the merger unit does not operate on both sides or is not reversible. For example, scraper members can be largely dispensed with on the infeed side or cut open there to give the conveyor tines and/or brushes more conveying effect there.

Irrespective of this, it can also be advantageous to provide the at least one or the scraper members only on one upper side of the spiked and/or brush roller, for example from about 11 o'clock to 13 o'clock.

However, the conveyor tines and/or brushes can also rotate in a controlled manner and, for example, be guided displaceably and controlled by a link-type control element, for example in the form of an orbital groove and a pin engaging therein, as is known per se in a pick-up spiked rotor with controlled tines. Advantageously, however, the conveyor tines or conveyor brushes are controlled in such a manner that they do not tilt along their revolving path, but only move in and out in a radial direction. This means that the rotor unit can be operated in opposite conveying directions, for example depositing to the right on one run and depositing to the left on another, without the auxiliary feeder interfering or obstructing the desired conveying direction. Since the conveyor tines or conveyor brushes only extend and retract radially in such a controlled manner, but otherwise retain their orientation, which can be at least approximately a radial orientation, the spiked or brush rotor can rotate both clockwise and counterclockwise and develop its desired conveying effect in both directions of rotation.

Irrespective of whether the conveyor tines and/or brushes are formed in a controlled or uncontrolled manner, the revolving path of the conveyor tines and/or brushes can also have a contour that deviates from the circular path, for example an elliptical or oval contour, so that the spiked or brush rotor has more or less the character of a belt rake if the revolving path is pressed more or less flat, for example has an oval contour.

With such a non-circular revolving path, it can be advantageous if the longer main axis of the revolving path is aligned horizontally and the shorter main axis of the revolving path is aligned upright. This gives the conveyor tines and/or brushes a particularly high conveying effect, as they can be active over a relatively longer distance and actively convey the harvested material. This active path is the side of the revolving path facing the cross conveyor.

Irrespective of the revolving path of the conveyor tines and/or brushes, it may be advantageous to divide the spiked and/or brush rotor into at least two, preferably also three or four rotor segments, each of the rotor segments comprising at least one or more conveyor tines and/or brushes. The rotor segments can in particular be configured in the manner of cake pieces, so that the spiked and/or brush rotor is composed of several wedge pieces or cake pieces, which are arranged with their tip or narrow end towards the axis of rotation.

Advantageously, the rotor segments can be configured identically to each other so that it is easy to replace any rotor segment with another rotor segment or only one rotor segment needs to be kept in stock in order to replace a worn or damaged rotor segment. For this purpose, each rotor segment can advantageously be fastened separately in a detachable manner, for example by means of screw bolts or a clamping plate or the like. In other words, a rotor segment can be removed and replaced, while the other rotor segments can remain mounted.

The rotor segments may each have an attachment foot portion to which the conveyor tines and/or brushes are fastened and from which the conveyor tines and/or brushes protrude, preferably in a fan-shaped manner. The attachment foot portion can preferably have a flat cake piece shape in order to be fastened to a rotatably mounted rotor hub.

In an advantageous further development of the invention, the rotor segments can be arranged spaced apart from one another and/or delimit a gap or radial gap between them. Spacing the rotor segments apart can facilitate separate assembly and disassembly. At the same time, however, a gap between the rotor segments can also be advantageous in order to prevent the harvested material from becoming entangled. The gap dimension can, for example, be at least 5 mm or even more than 10 mm, wherein according to an advantageous embodiment the gap or radial gap can have a gap width in the range of 5 mm-15 mm.

The gap between the rotor segments can advantageously extend to the axis of rotation and/or be provided at least between the attachment foot portions.

If the rotor segments each have only one conveyor tine, maximum subdivision is achieved and the gaps between the segments can extend between adjacent conveyor tines deep towards the axis of rotation. If there are several conveyor tines on a segment, the gaps can extend to the right and left of the segment to the adjacent segments and reach as far as the axis of rotation.

In an advantageous further development of the invention, the rotor segments can each be integrally formed in one piece, made of homogeneous material, wherein the one-piece, homogeneous material formation can comprise both the conveyor tines and/or brushes and the attachment foot portions. In particular, the conveyor tines and/or brushes can be integrally formed in one piece on the attachment foot portions. Alternatively, however, it would also be possible to form the conveyor tines and/or brushes separately from the attachment foot portion and to attach them rigidly thereto.

In particular, the rotor segments can be made of an elastic, for example rubber-elastic material.

In a further development of the invention, the conveyor tines and/or brushes can define with their protruding ends an outer diameter of the spiked and/or brush rotor which is more than 150% or more than 200%, in particular about 200-300% of an inner diameter which is defined by foot portions of the conveyor tines and/or brushes and/or the attachment foot portion from which the conveyor tines and/or brushes protrude.

In a further development of the invention, it may also be advantageous to subdivide the spiked and/or brush rotor in a plane transverse to the axis of rotation. For example, two spiked and/or brush rotors may be spaced apart from each other coaxially and/or at least approximately parallel to each other. In particular, two or more than two spiked and/or brush rotors can rotate around the same axis of rotation. This makes it possible, for example, to widen or narrow the spiked and/or brush rotor depending on the harvested material by mounting one or more additional spiked and/or brush rotors on or removing them from the axis of rotation. If necessary, spacers can also be used between the several brush and/or spiked rotors to change their spacing and thereby achieve a widening or narrowing of the group of rotors. If necessary, however, the multiple spiked and/or brush rotors can also sit directly on top of each other, in particular in such a manner that the tines or brushes or fingers are aligned with each other when viewed in the direction of the axis of rotation. If the arrangement is spaced apart in the direction of the axis of rotation, the rotors may also rotate independently of one another and/or rotate relative to one another, in particular in the case of a free-moving arrangement in which the harvested material drives the rotors.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The invention is explained in more detail below with reference to an advantageous embodiment and corresponding drawings. The drawings show:

FIG. 1 is a sectional, perspective view of the merger unit of an agricultural harvesting machine according to an advantageous embodiment of the invention, showing an upstream portion of the cross conveyor of the merger unit and the auxiliary feeder arranged above it in the form of a spiked and/or brush rotor.

FIG. 2 is a sectional front view of the merger unit from FIG. 1, showing the spiked and/or brush rotor above the cross conveyor track of the merger unit.

FIG. 3 is a side view of the merger unit from the preceding figures in a viewing direction corresponding to the conveying direction of the cross conveyor, with the auxiliary feeder shown above the cross conveyor.

FIG. 4 is a sectional front view of the merger unit, showing the spiked and/or brush rotor above the cross conveyor track of the merger unit without scraper.

FIG. 5 is a perspective view of a segmented spiked and/or brush rotor comprising four separate rotor segments spaced apart from each other, according to a further advantageous embodiment of the invention.

FIG. 6 is a perspective view of one of the rotor segments of the segmented rotor of FIG. 5, which comprises a plurality of conveyor tines or fingers protruding in a fan-shaped manner from an attachment foot portion.

FIG. 7 is a top view of the segmented spiked and/or brush rotor in FIG. 5.

FIG. 8 is a sectional view of the segmented spiked and/or brush rotor from the previous figures, showing the attachment of the rotor segments to a rotatably mounted rotor hub.

FIG. 9 is a frontal view of a rotor segment of the segmented spiked and/or brush rotor from the previous figures.

FIG. 10 is a plan view of the circumferential side of a rotor segment.

FIG. 11 is a sectional view of the rotor segments along a sectional plane passing through the axis of rotation and one of the conveyor tines or fingers.

FIG. 12 is a perspective view of a rotor segment.

FIG. 13 is a perspective view of the segmented spiked and/or brush rotor in its installation environment above the conveyor track of a merging device, on the rear wall thereof, wherein, according to an advantageous embodiment of the invention, two segmented spiked and/or brush rotors are mounted coaxially to one another on the same axis of rotation.

FIG. 14 is a perspective view of a segmented conveyor rotor in its installation environment above the conveyor track of a merging machine, a scraper member being provided between the rotor and the rear wall of the merging machine, along which the conveyor tines of the rotor scrape.

### DETAIL DESCRIPTION OF THE INVENTION

As shown in the figures, the agricultural harvesting machine 1 can, for example, be configured in the form of a windrower to be able to pick up harvested material scattered on the ground and deposit a swath. However, the harvester 1 can also be configured as a combination device and comprise, for example, a mower, at the downstream end of which the merger unit 2 of the harvesting machine 1 is then arranged.

As shown in the figures, the merger unit 2 comprises a horizontally arranged cross conveyor 3, which may, for example, be a belt conveyor and comprise an endlessly circulating driven conveyor belt 4. As mentioned at the beginning, instead of a continuous conveyor belt, a belt conveyor with several endlessly circulating conveyor belts or chains arranged next to each other, or possibly also a roller conveyor could be provided as the cross conveyor 3. In any case, the cross conveyor 3 can have a horizontal, preferably approximately flat conveyor track 5, which extends transversely to the direction of travel 6.

In order to be able to pick up harvested material lying on the ground, the merger unit 2 comprises a pick-up conveyor 7, which can be configured, for example, in the manner of a pick-up with a spiked roller 8 that can be driven in rotation. The harvested material picked up by the pick-up conveyor 7 can be deposited on the conveyor track 5 of the cross conveyor 3 and conveyed by the latter transversely to the direction of travel 6 to one side and then deposited in a swath.

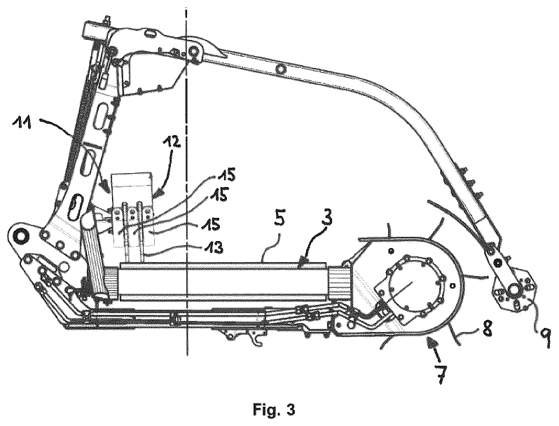

As shown in FIG. 3, to the pick-up conveyor 7 there can be assigned a hold-down device 9, for example comprising an infeed roller or another infeed element controlling the infeed, for example with a gate-like infeed rake or guide plate or the like.

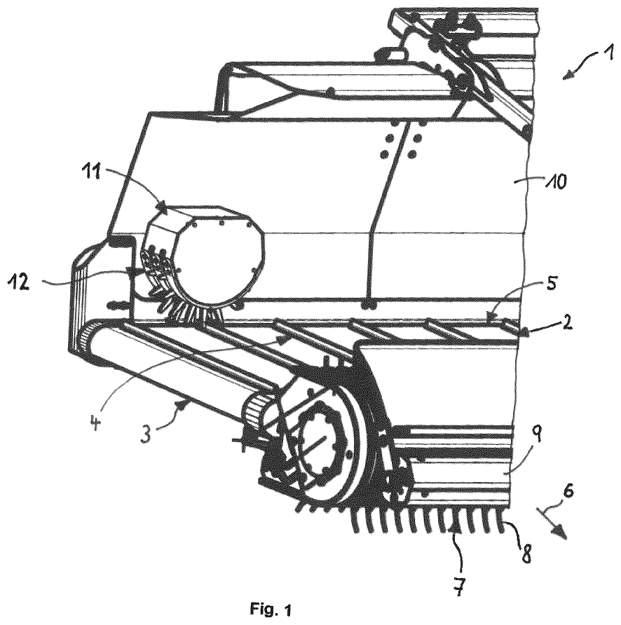

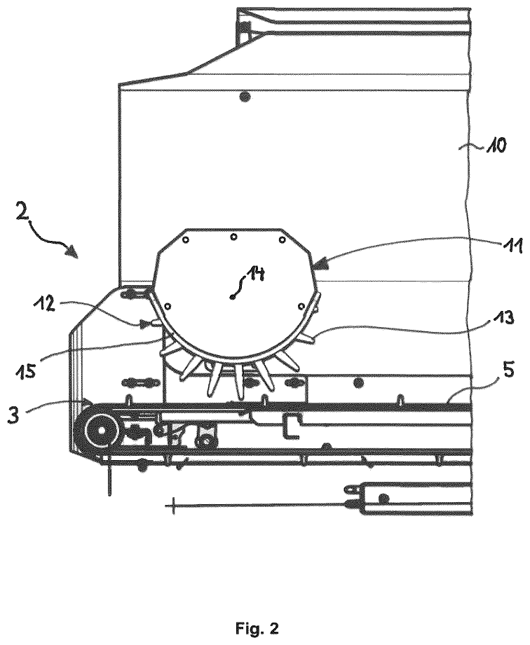

As shown in FIGS. 1 and 2, the cross conveyor 3 can be bounded at its rear edge portion—when viewed in the direction of travel 6-by an upright wall 10, which prevents the harvested material from falling down on the edge portion of the cross conveyor 3 opposite the pick-up conveyor 7 and/or guides the harvested material along the cross conveyor 3.

As shown in the figures, an auxiliary feeder 11 is also provided above the cross conveyor 3 in at least one edge portion or end portion of the cross conveyor 3, which can be mounted or arranged, for example, on the side of the wall 10 facing the cross conveyor 3.

The auxiliary feeder 11 comprises a spiked and/or brush rotor 12, which comprises a plurality of conveyor tines 13 and/or conveyor brushes 13, which are distributed in the circumferential direction of the rotor. As FIG. 3 illustrates, the spiked and/or brush rotor 12 can comprise several rows of such conveyor tines and/or conveyor brushes 13, which can be arranged in parallel planes spaced apart from one another, and in particular can be arranged offset in the direction of the axis of rotation 14.

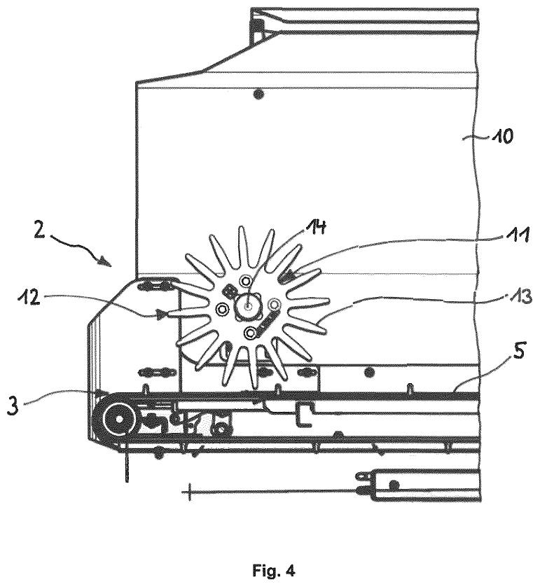

FIG. 4 shows the distribution of the conveyor tines and/or brushes 13 and their contouring even more clearly. As shown in FIG. 4, the spiked and/or brush rotor 12 with its conveyor tines and/or brushes 13 can have an approximately star-shaped contour when viewed as a whole. However, in particular when designed as a brush with a plurality of brushes, the spiked and/or brush rotor 12 can also have a less star-shaped contour and/or comprise a more uniform contour in the circumferential direction and/or have a more “swirly” or more unstructured distribution of the conveying brushes 13.

It is also possible, for example, to provide one row of conveyor brushes 13 and one row of conveyor tines 13, wherein, for example, softer conveyor brushes 13 can be provided in the front row in the direction of travel 6 and stiffer conveyor tines 13 in the rear row in the direction of travel 6.

As shown in the FIGS. 1 to 3, the conveyor tines and/or brushes 13 can be arranged between scraper members 15, which can extend in an arc-shaped manner around the axis of rotation 14 and define slots between them, through which the conveyor tines and/or brushes 13 can extend.

As shown in FIG. 2, the scraper members 15 can be contoured and/or adapted to the revolving path of the conveyor tines and/or brushes 13 in such a manner that the projecting length of the conveyor tines and/or brushes 13 varies or changes along the revolving path. In particular, the protruding length of the conveyor tines and/or brushes 13 can be maximum in a sector of the revolving path that includes a perpendicular to the cross conveyor 3, for example around 6 o'clock, and can become smaller or shorter towards adjacent, adjoining areas, for example in areas 7-9 o'clock and 3-5 o'clock, cf. FIG. 2.

In other words, the scraper members 15 can be contoured in such a manner that the conveyor tines and/or brushes 13 initially extend further along their revolving path around the axis of rotation 14 between the scraper members 15 until they are extended to the maximum in a position directly opposite the cross conveyor 3, and then retract further again in order to scrape the harvested material off at the intended depositing region of the auxiliary feeder 11, cf. Depending on the direction of rotation of the spiked and/or brush rotor 12, the depositing region can be arranged approximately in the area between 7 o'clock and 9 o'clock, for example around 8 o'clock, or between 5 o'clock and 3 o'clock, for example around 4 o'clock.

If the conveyor tines and/or brushes 13 rotate uncontrolled on a circular path, the retraction and extension relative to the scraper members 15 can be achieved by an arc-shaped manner of contouring the scraper members 15 that deviates from the circular shape, as shown for example in FIG. 2. For example, the spacing of the scraper members 15 in the intended depositing sector can be greater than in the intended conveying sector.

Alternatively or additionally, however, a control system for the conveyor tines and/or brushes 13 can also be provided and in particular be configured in such a manner that the conveyor tines and/or brushes 13 can move in and out in a radial direction relative to the axis of rotation.

Such controlled conveyor tines and/or brushes 13 can, for example, be guided displaceably on a rotatably mounted carrier and controlled by a link-type control element, for example in the form of a rotary groove and a pin engaging therein, as is known per se in a pickup spiked rotor with controlled tines. Advantageously, however, the conveyor tines 13 or conveyor brushes 13 of the spiked and/or brush rotor 12 are controlled in such a manner that they do not tilt along their revolving path, but only move in and out in a radial direction. This means that the merger unit 2 can be operated in opposite conveying directions, for example depositing to the right and depositing to the left on another run, without the auxiliary feeder 11 interfering or obstructing the desired conveying direction. Since the conveyor tines or conveyor brushes 13 in such a controlled manner only extend and retract radially, but otherwise maintain their orientation, which in particular can be at least approximately a radial orientation, the spiked or brush rotor 12 can rotate equally clockwise and counterclockwise and develop its desired conveying effect in both directions of rotation. It should be noted that the conveyor tines 13 can nevertheless have an inclined position, e.g. conical, or can be beveled or bent in such a way that together they define an enveloping surface, e.g. in the shape of a soup plate. Such an inclined position does not hinder the conveying effect when the direction of rotation is reversed.

As shown in FIG. 14, it may also be sufficient to use or provide only one scraper member 15, which may be arranged on an end face of the spiked and/or brush rotor 12, so that the conveyor tines and/or brushes 13 are arranged directly next to the scraper member 15 and/or pass this scraper member 15 at a short distance. In particular, such a scraper member 15 may be provided between the spiked and/or brush rotor 12 and a rear wall 10 of the merging device and/or extend in a plane perpendicular to the axis of rotation 14. The scraper member 15 can be in the form of a scraper plate, but in particular can also be in the form of a scraper plate, which is positioned end to end with the rotor, so that the circumferential contour of the scrapers forms the scraper contour.

Advantageously, the scraper member can have an oval or elliptical contour or the shape of a flattened or flattened ring, whereby the longer main axis of the contour of the scraper member 15 can be aligned, in particular perpendicular to the axis of rotation 14 and parallel to the conveyor track 5 of the merger.

Due to the flattened, in particular oval or elliptical contour, the conveyor tines and/or brushes on the lower side protrude as far as possible or quite far beyond the scraper member, while the protrusion of the conveyor tines and/or brushes 13 beyond the scraper member 15 decreases on both sides, more precisely towards 3 o'clock and 9 o'clock, cf. FIG. 14. On the upper side, the conveyor tines 13 can protrude further beyond the scraper member 15 again, as the harvested material has already been scraped off here. For example, the conveyor tines 13—when viewed in the direction of the axis of rotation 14—can dip completely below the contour of the scraper member 15 in the area of 9 o'clock and 3 o'clock or in the area around the length of the main axis of the contour of the scraper member 15 or no longer have any projection in order to ensure that the harvested material is reliably scraped off.

As shown in FIG. 4, the spiked and/or brush rotor 12 can also be used without a scraper 15, especially if harvested material is to be processed that does not tend to stick or get tangled on the conveyor tines and/or brushes 13. Even in the case of a design as a brush rotor 12 with finer, elastic conveyor brushes 13, it may be possible to work without a scraper 15 even with sticky or matted harvested material, as the conveyor brushes can shake off the harvested material, so to speak, due to their elasticity and a spring-back or restoring movement at the depositing region due to the decreasing harvest pressure on the brushes there.

The conveyor tines and/or brushes 13 can advantageously be designed to be elastically yielding in order to be able to spring away elastically or bend away yielding in intended operation under the action of the harvested material to be conveyed, in the manner of a bending beam. For example, rubber-elastic brushes or plastic tines can be used, the stiffness of which is low enough to be able to deform under the pressure of the harvested material, whereby stronger deformations can also occur, which can lead to bending angles of more than 20° or more than 30°, for example. This helps to shake off the harvested material in the intended depositing region of the spiked and/or brush rotor 12 and release it from the conveyor tines or 13.

However, tines made of metal or steel are also possible, wherein the desired flexibility can be achieved through appropriate slenderness and/or choice of material, such as spring steel.

In a further development of the invention, the conveyor tines 13 or conveyor brushes 13 are characterized by a slender, elongate contour, wherein a ratio of the protruding length of the conveyor tines or brushes 13 to their diameter or thickness can be an integral multiple. For example, the conveyor tines and/or brushes 13 may be more than three times or more than five times or more than ten times longer than thick.

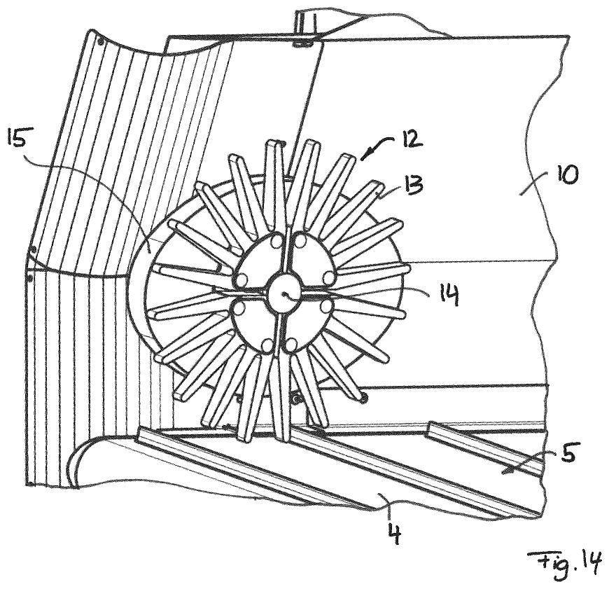

In a further development of the invention, the spiked and/or brush rotor 12 can be subdivided in a plane transverse to the axis of rotation 14, or two or more than two spiked and/or brush rotors 12 can be arranged one behind the other in the direction of the axis of rotation 14, cf. FIG. 13. In this manner, the thickness or width of the rotor in the direction of the axis of rotation 14 can be adapted to different types of harvest.

For example, two spiked and/or brush rotors 12 may be provided coaxially to each other and/or at least approximately parallel to each other, spaced apart from each other. In particular, two or more than two spiked and/or brush rotors 12 can rotate around the same axis of rotation 14. This makes it very easy to widen or narrow the spiked and/or brush rotor 12, depending on the harvested material, by mounting one or more additional spiked and/or brush rotors 12 on or removing them from the axis of rotation. If necessary, spacers can also be used between the several brush and/or spiked rotors 12 to change their spacing and thereby achieve a widening or narrowing of the group of rotors. If necessary, however, the multiple spiked and/or brush rotors 12 can also sit directly on top of each other, in particular in such a way that the tines 13 or brushes or fingers are aligned with each other when viewed in the direction of the axis of rotation 14, cf. FIG. 13.

If spaced apart in the direction of the axis of rotation 14, the rotors 12 may also rotate independently of one another and/or rotate relative to one another, in particular in the case of a free-moving arrangement in which the harvested material drives the rotors 12.

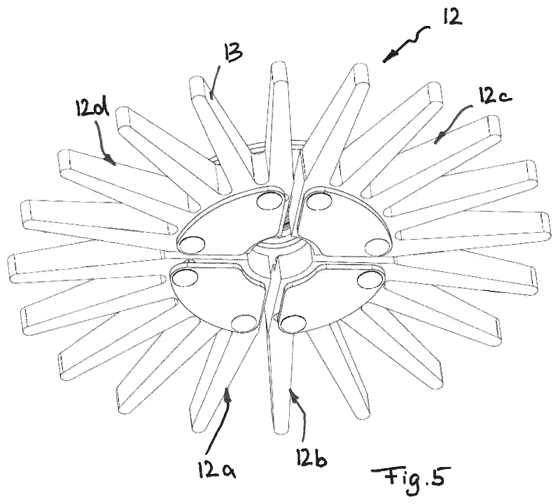

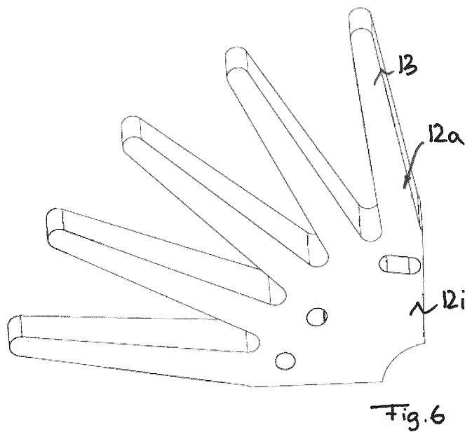

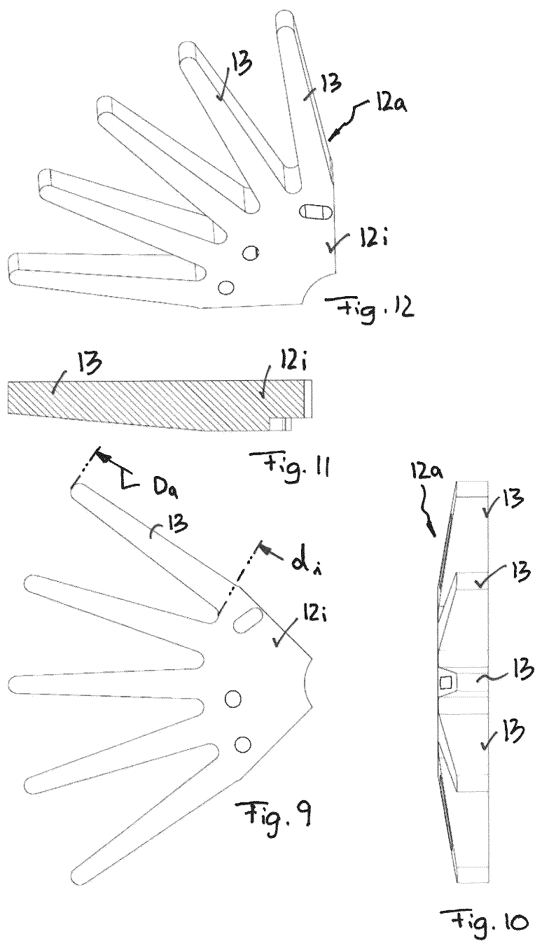

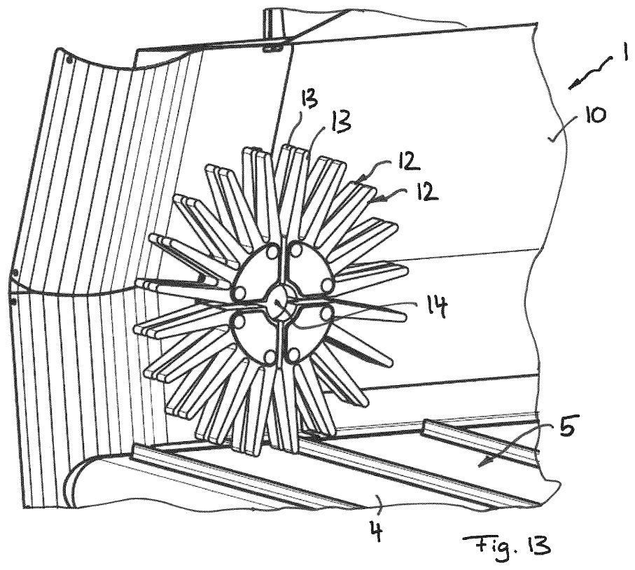

As shown in the FIG. 13, but also in FIGS. 5 to 12 and 14, the spiked and/or brush rotor 12 can advantageously be divided or segmented into several rotor segments 12a and b, for example into four such rotor segments 12a-d, each of which can cover a rotor range of approximately 90 °.

Each of the rotor segments 12a-d may comprise at least one or more conveyor tines and/or brushes 13. The rotor segments 12a-d can in particular be configured in the manner of cake pieces, so that the spiked and/or brush rotor 12 is composed of several wedge pieces or cake pieces, which are arranged with their tip or narrow end towards the axis of rotation 14, cf. FIGS. 5 and 7.

Advantageously, the rotor segments 12a-d can be configured identically to each other, so that it is possible to replace any rotor segment 12a with another rotor segment 12b-d in a simple manner or only one rotor segment needs to be kept in stock in order to be able to replace a worn or damaged rotor segment. For this purpose, each rotor segment 12a-d can advantageously be fastened separately in a detachable manner, for example by means of screw bolts 19, clamping levers or a clamping plate 18 or the like, cf. FIGS. 7 and 8.

In other words, one rotor segment 12a-d can be removed and replaced, while the remaining rotor segments 12a-d can remain mounted.

The rotor segments 12a-d may each have an attachment foot portion 12i to which the conveyor tines and/or brushes 13 are fastened and from which the conveyor tines and/or brushes 13 protrude, preferably in a fan-shaped manner. The attachment foot portion 12i can preferably have a flat cake piece shape in order to be fastened to a rotatably mounted rotor hub 17, cf. FIGS. 7 and 8.

In an advantageous further development of the invention, the rotor segments 12a-d can be arranged spaced apart from one another and/or delimit a gap 16 or radial gap between them. Spacing the rotor segments 12a-d apart can facilitate separate assembly and disassembly. At the same time, however, the gap 16 between the rotor segments 12a-d can also be advantageous in order to prevent the harvested material from becoming entangled. The gap dimension can, for example, be at least 5 mm or even more than 10 mm, wherein according to an advantageous embodiment the gap 16 or radial gap can have a gap width in the range of 5 mm-15 mm.

The gap 16 between the rotor segments can advantageously extend to the axis of rotation 14 and/or be provided at least between the attachment foot portions, cf. FIGS. 5 and 7.

If the rotor segments 12a-d each have only one conveyor tine 13, maximum subdivision is achieved and the gaps 16 between the segments can extend between adjacent conveyor tines 13 deep towards the axis of rotation 14. In the case of several conveyor tines 13 on a segment 12a-d, the gaps 16 can extend to the right and left of the segment to the respective adjacent segments and reach as far as the axis of rotation 14, cf. FIG. 7.

In an advantageous further development of the invention, the rotor segments 12a-d can each be integrally formed in one piece, made of homogeneous material, wherein the one-piece, homogeneous material formation can comprise both the conveyor tines and/or brushes 13 and the attachment foot portions 12i. In particular, the conveyor tines and/or brushes 13 can be integrally formed in one piece, homogeneously in terms of material, on the attachment foot portions 12i. Alternatively, however, it would also be possible to form the conveyor tines and/or brushes 13 separately from the attachment foot portion 12i and to attach them rigidly thereto.

In particular, the rotor segments 12a-d can be made of an elastic, for example rubber-elastic material.

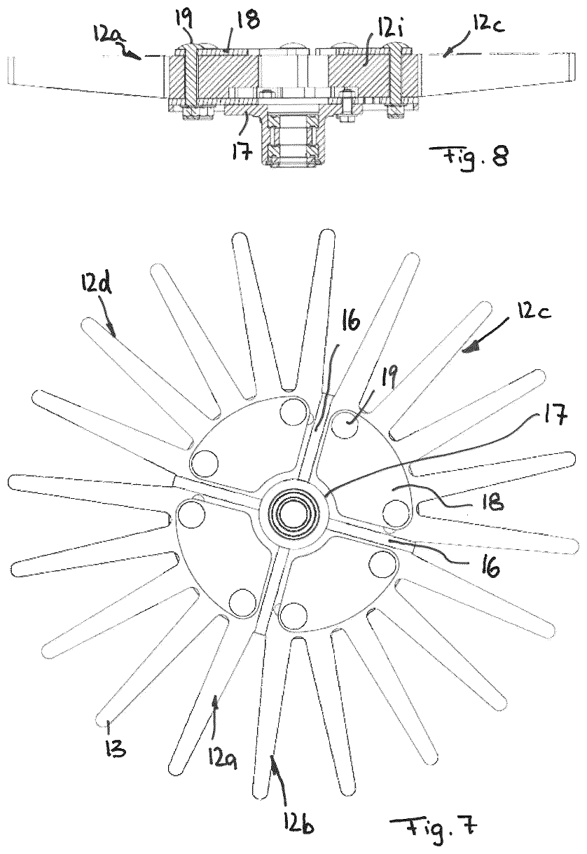

In a further development of the invention, the conveyor tines and/or brushes 13 can define with their protruding ends an outer diameter Da of the spiked and/or brush rotor 12, which is more than 150% or more than 200%, in particular about 200-300% of an inner diameter di, which is defined by foot portions of the conveyor tines and/or brushes 13 and/or the attachment foot portion 12i, from which the conveyor tines and/or brushes 13 protrude, cf. FIG. 9.

1. An agricultural harvesting machine comprising:
a merger unit comprising:
a pick-up conveyor for picking up harvested material from the ground; and
a cross conveyor having:
a horizontal conveyor track for conveying the picked-up harvested material transversely to a direction of travel; and
an auxiliary feeder in at least one edge portion of the cross conveyor above the conveyor track for discharging accumulations of harvested material on the conveyor track and/or for cleaning the conveyor track of the cross conveyor;
wherein the auxiliary feeder has a spiked and/or brush rotor with conveyor tines and/or brushes rotating about an axis of rotation.

2. The agricultural harvesting machine according to claim 1, wherein the axis of rotation of the spiked and/or brush rotor is aligned horizontally, approximately parallel to the direction of travel.

3. The agricultural harvester according to claim 1, wherein the conveyor tines and/or brushes are arranged next to at least one scraper member or between scraper members and project beyond each scraper member towards the cross conveyor in a portion of a revolving path around the axis of rotation facing the conveyor track.

4. The agricultural harvesting machine according to claim 3, wherein:
the conveyor tines and/or brushes project along the revolving path about the axis of rotation to different extents beyond the at least one each scraper member; and
a projecting length of the conveyor tines and/or brushes has a maximum in a portion of the revolving path directly facing the conveyor track of the cross conveyor and has a minimum in an intended depositing region of the spiked and/or brush rotor and/or becomes continuously smaller towards the depositing region.

5. The agricultural harvesting machine according to claim 3, wherein:
the conveyor tines and/or brushes rotate uncontrolled about the axis of rotation and each scraper member is spaced at different distances from the axis of rotation in different sectors along the revolving path of the conveyor tines and/or brushes; and
each scraper member is contoured in an arc-shaped manner such that a distance of the scraper member from the axis of rotation is minimal in a region directly opposite the cross conveyor and becomes continuously greater towards an intended depositing region of the spiked and/or brush roller.

6. The agricultural harvesting machine according to claim 1, wherein the conveyor tines and/or brushes rotate in a controlled manner around the axis of rotation in such a manner that the conveyor tines and/or brushes are retracted and extended along a revolving path in a radial direction to the axis of rotation.

7. The agricultural harvesting machine according to claim 1, wherein the conveyor tines and/or brushes are aligned in a circular revolving path around the axis of rotation.

8. The agricultural harvesting machine according to claim 1, wherein the conveyor tines and/or brushes are aligned in a revolving path deviating from a circular shape.

9. The agricultural harvesting machine according to claim 3, wherein:
each scraper member (45) has an oval or elliptical contour around the axis of rotation; and
a longer main axis of the oval or elliptical contour is aligned horizontal or parallel to the conveyor track.

10. The agricultural harvesting machine according to claim 3, wherein at least one scraper member is provided only on one side of the spiked and/or brush rotor between the spiked and/or brush rotor and an uprightly extending rear wall of the merger unit.

11. The agricultural harvesting machine according to claim 1, wherein the conveyor tines and/or brushes are configured to be elastically yielding in such a manner as to deform elastically during operation of the agricultural harvesting machine.

12. The agricultural harvesting machine according to claim 11, wherein the conveyor tines and/or brushes are configured to be rubber-elastic.

13. The agricultural harvesting machine according to claim 11, wherein the conveyor tines and/or brushes have a freely protruding tine and/or brush length which is at least three times as great as a thickness of the conveyor tines and/or brushes.

14. The agricultural harvesting machine according to claim 1, wherein:
the spiked and/or brush rotor is divided into at least two rotor segments; and
each rotor segment comprises at least one of the conveyor tines and/or brushes.

15. The agricultural harvesting machine according to claim 14, wherein the rotor segments form rotor sectors that are spaced apart and/or define between rotor sectors a gap or radial gap having a gap width of at least 5 mm.

16. The agricultural harvesting machine according to claim 14, wherein each rotor segment has an attachment foot portion to which the conveyor tines and/or brushes are attached and from which the conveyor tines and/or brushes protrude.

17. The agricultural harvesting machine according to claim 14, wherein the rotor segments are fastened independently of one another and/or are mounted so as to be individually replaceable.

18. The agricultural harvesting machine according to claim 14, wherein each rotor segment is integrally formed in one piece.

19. The agricultural harvesting machine according to claim 1, wherein the spike and/or brush rotor with the conveyor tines and/or brushes define an outer diameter which is more than 150% of an inner diameter defined by foot portions of the conveyor tines and/or brushes and/or an attachment foot portion from which the conveyor tines and/or brushes protrudes.

20. The agricultural harvesting machine according to claim 1 comprising two of the spike and/or brush rotors;
wherein the spike and/or brush rotors:
are arranged coaxially with each other;
are arranged parallel to each other;
are spaced apart from each other; and/or
each comprise conveyor tines and/or brushes rotating about the axis of rotation.

21. The agricultural harvesting machine according to claim 1, wherein with the spike and/or brush rotor there is associated an enclosure which is completely closed at an upper side of the spike and/or brush rotor.

22. The agricultural harvesting machine according to claim 1, wherein the spike and/or brush rotor is configured to be operated in opposite directions of rotation and in an identical manner with respect to the opposite directions of rotation.

23. The agricultural harvesting machine according to claim 1, wherein the spike and/or brush rotor is rotatable in a free-running manner and configured to be driven solely by the harvested material.

24. The agricultural harvesting machine according to claim 1, wherein the spike and/or brush rotor is configured to be driven by an externally energy-operated rotor drive.

25. The agricultural harvesting machine according to claim 24, wherein the rotor drive is configured to be operated at a conveying speed at which the conveying tines and/or brushes have a conveying speed that differs from the cross conveyor.

26. The agricultural harvesting machine according to claim 24, wherein the rotor drive is configured to be variably adjustable in a conveying speed.

27. The agricultural harvesting machine according to claim 1, wherein at least one of:
the spiked and/or brush rotor is divided into three or more rotor segments;
each rotor segment has the same number of conveyor tines and/or brushes; or
all rotor segments are configured in an identical manner.

28. The agricultural harvesting machine according to claim 1, wherein the spike and/or brush rotor with the conveyor tines and/or brushes define an outer diameter which is from 200% to 300% of an inner diameter defined by foot portions of the conveyor tines and/or brushes and/or an attachment foot portion from which the conveyor tines and/or brushes protrudes.

29. The agricultural harvesting machine according to claim 8, wherein the revolving path is an elliptical or oval shape.

30. The agricultural harvesting machine according to claim 11, wherein the conveyor tines and/or brushes have a freely protruding tine and/or brush length which is at least ten times as great as a thickness of the conveyor tines and/or brushes.

31. The agricultural harvesting machine according to claim 14, wherein the rotor segments form rotor sectors that are spaced apart and/or define between rotor sectors a gap or radial gap having a gap width of from 5 mm to 15 mm.

32. The agricultural harvesting machine according to claim 14, wherein:
each rotor segment has an attachment foot portion to which the conveyor tines and/or brushes are attached and from which the conveyor tines and/or brushes protrude in a fan-shaped manner; and
each attachment foot portion has a flat cake piece shape.

33. The agricultural harvesting machine according to claim 14, wherein each rotor segment is integrally formed in one piece, made of a homogeneous, rubber-elastic material.

34. The agricultural harvesting machine according to claim 24, wherein the rotor drive is configured to be operated at a conveying speed at which the conveying tines and/or brushes have a higher conveying speed than that from the cross conveyor.
